(19) United States
(12) Patent Application Publication
(10) Pub. No.: US 2021/0105412 A1
(43) Pub. Date: Apr. 8, 2021

(54) IMAGE SENSOR WITH PIXELATED CUTOFF FILTER FOR PHASE DETECTION AUTOFOCUS

(71) Applicant: QUALCOMM Incorporated, San Diego, CA (US)

(72) Inventors: Nan Cui, San Diego, CA (US); Wenbin Wang, San Diego, CA (US); Zuguang Xiao, San Diego, CA (US)

(21) Appl. No.: 16/591,525

(22) Filed: Oct. 2, 2019

(51) Int. Cl. H04N 5/232; H04N 5/225

(52) U.S. Cl. CPC H04N 5/232122; H04N 5/232123; H04N 5/2254; H04N 5/2256

(57) ABSTRACT

Methods, systems, and devices for image processing are described. A device may emit light from a light source and capture one or more images using an image sensor based on the emitted light. The device may emit light based on identifying a low lighting condition. The image sensor may include a set of non-phase detection pixels, a set of phase detection pixels, and a pixelated filter layer deposited over the set of non-phase detection pixels. The device may perform an autofocus operation based on an image offset associated with at least two phase detection pixels and the one or more images. Subsequently, the device may generate the one or more images based on the autofocus operation.

### FIELD OF INVENTION

The following relates generally to image processing, and more specifically to an image sensor with a pixelated cutoff filter for phase detection autofocus.

### BACKGROUND

A device may include an optical instrument (e.g., a camera, an image sensor, etc.) for recording or capturing images, which may be stored locally, transmitted to another location, etc. For example, an image sensor may capture visual information using one or more photosensitive elements that may be tuned for sensitivity to a visible spectrum of electromagnetic radiation. Many electronic devices, such as smartphones, tablets, home security systems, automobiles, drones, aircrafts, etc. may use one or more cameras (e.g., sensors) to capture images and video. Additionally, electronic devices may use one or more light sources to illuminate target objects or target areas to be captured in an image or video. In some examples, cameras and light sources may be unable to effectively provide images having high image quality under low lighting conditions.

Some devices may support phase detection autofocus technology for improving performance (e.g., autofocus performance) related to image capture. In low lighting conditions (e.g., under 5 lux), however, phase detection autofocus technology may suffer from errors in sub-pixel phase difference estimations due to higher amounts of noise (e.g., significantly decreased signal-to-noise ratio (SNR)), resulting in reduced image quality.

### SUMMARY

The described techniques relate to improved methods, systems, devices, and apparatuses that support image processing, and more specifically, an image sensor with a pixelated cutoff filter for phase detection autofocus. Generally, the described techniques provide for improved image processing and may support phase detection autofocus technology for improving performance related to image capture.

A device may include an image sensor and a filter layer (e.g., a pixelated infrared (IR) cutoff filter), where the filter layer is directly deposited only over non-phase detection pixels (e.g., color pixels, monochrome pixels, etc.) of the image sensor and not over phase detection pixels (e.g., phase detection autofocus pixels) of the image sensor. In some examples, the device may further include a light source (e.g., an active IR light source, a near-IR light source, an ultraviolet light source, etc.) capable of emitting invisible or nearly visible light. Using the improved image sensor together with the light source, the device may provide the phase detection pixels in the image sensor with sufficient amounts of light (e.g., IR light) for improved autofocus and image quality under low lighting conditions. As the improved methods and devices may be implemented without requiring a time-of-flight sensor or other sensor, manufacturing costs and computation requirements may be reduced.

A method of image processing at a device is described. The method may include emitting light from a light source, capturing one or more images using an image sensor based on the emitted light, where the image sensor includes a set of non-phase detection pixels, a set of phase detection pixels, and a pixelated filter layer deposited over the set of non-phase detection pixels, performing an autofocus operation based on an image offset associated with at least two phase detection pixels in the set of phase detection pixels and the one or more images, and generating the one or more images based on the autofocus operation.

An apparatus for image processing at a device is described. The apparatus may include a processor, memory coupled with the processor, and instructions stored in the memory. The instructions may be executable by the processor to cause the apparatus to emit light from a light source, capture one or more images using an image sensor based on the emitted light, where the image sensor includes a set of non-phase detection pixels, a set of phase detection pixels, and a pixelated filter layer deposited over the set of non-phase detection pixels, perform an autofocus operation based on an image offset associated with at least two phase detection pixels in the set of phase detection pixels and the one or more images, and generate the one or more images based on the autofocus operation.

Another apparatus for image processing at a device is described. The apparatus may include means for emitting light from a light source, capturing one or more images using an image sensor based on the emitted light, where the image sensor includes a set of non-phase detection pixels, a set of phase detection pixels, and a pixelated filter layer deposited over the set of non-phase detection pixels, performing an autofocus operation based on an image offset associated with at least two phase detection pixels in the set of phase detection pixels and the one or more images, and generating the one or more images based on the autofocus operation.

A non-transitory computer-readable medium storing code for image processing at a device is described. The code may include instructions executable by a processor to emit light from a light source, capture one or more images using an image sensor based on the emitted light, where the image sensor includes a set of non-phase detection pixels, a set of phase detection pixels, and a pixelated filter layer deposited over the set of non-phase detection pixels, perform an autofocus operation based on an image offset associated with at least two phase detection pixels in the set of phase detection pixels and the one or more images, and generate the one or more images based on the autofocus operation.

Some examples of the method, apparatuses, and non-transitory computer-readable medium described herein may further include operations, features, means, or instructions for identifying a low lighting condition, where the emitted light may be based on the identified low lighting condition. Some examples of the method, apparatuses, and non-transitory computer-readable medium described herein may further include operations, features, means, or instructions for processing the one or more images based on the set of non-phase detection pixels and the autofocus operation, where the one or more images may be generated based on the processing. In some examples of the method, apparatuses, and non-transitory computer-readable medium described herein, the light source includes one or more of an infrared light source, a near-infrared light source, and an ultraviolet light source, and the pixelated filter layer includes one or more of a pixelated infrared filter layer, a pixelated near-infrared filter layer, and a pixelated ultraviolet filter layer.

In some examples of the method, apparatuses, and non-transitory computer-readable medium described herein, the pixelated filter layer may be directly deposited over the set of non-phase detection pixels. In some examples of the method, apparatuses, and non-transitory computer-readable medium described herein, the pixelated filter layer may be deposited only over the set of non-phase detection pixels.

In some examples of the method, apparatuses, and non-transitory computer-readable medium described herein, the set of non-phase detection pixels includes a set of color pixels. Some examples of the method, apparatuses, and non-transitory computer-readable medium described herein may further include operations, features, means, or instructions for performing a contrast autofocus operation based on a contrast level associated with at least two color pixels in the set of color pixels and the one or more images, where generating the one or more images may be further based on the contrast autofocus operation.

In some examples of the method, apparatuses, and non-transitory computer-readable medium described herein, the set of non-phase detection pixels includes a set of color pixels, a set of monochrome pixels, or both. In some examples of the method, apparatuses, and non-transitory computer-readable medium described herein, the set of phase detection pixels include a set of phase detection autofocus pixels. In some examples of the method, apparatuses, and non-transitory computer-readable medium described herein, the pixelated filter layer includes a thin-film-based optical filter layer.

In some examples of the method, apparatuses, and non-transitory computer-readable medium described herein, the pixelated filter layer includes a mesh structure formed of two or more materials. In some examples of the method, apparatuses, and non-transitory computer-readable medium described herein, the two or more materials may be at least partially interlaced within the mesh structure. In some examples of the method, apparatuses, and non-transitory computer-readable medium described herein, the two or more materials differ based on one or more of a refractive index and a thickness of each of the two or more materials.

### BRIEF DESCRIPTION OF THE DRAWINGS

FIG. 1 illustrates an example of a system that supports image capture techniques and image processing in accordance with aspects of the present disclosure.

FIG. 2 illustrates an example of a device architecture that supports image capture and image processing in accordance with aspects of the present disclosure.

FIG. 3 illustrates an example of an image capture diagram that supports aspects of an image sensor with a pixelated cutoff filter for phase detection autofocus in accordance with examples of aspects described herein.

FIGS. 4 and 5 show block diagrams of devices that support an image sensor with a pixelated cutoff filter for phase detection autofocus in accordance with aspects of the present disclosure.

FIG. 6 shows a block diagram of a controller that supports an image sensor with a pixelated cutoff filter for phase detection autofocus in accordance with aspects of the present disclosure.

FIGS. 7 and 8 show flowcharts illustrating methods that support an image sensor with a pixelated cutoff filter for phase detection autofocus in accordance with aspects of the present disclosure.

### DETAILED DESCRIPTION

Some devices may support phase detection autofocus technology for improving performance (e.g., autofocus performance) related to image capture. Some devices using phase detection autofocus technology (e.g., an image capture device, such as a camera device) may determine a lens focus phase difference among photodetectors to improve autofocus speed when capturing an image or video (e.g., of a target object or a physical area associated with the target object). For example, a device incorporating phase detection autofocus technology may determine a phase difference or offset between pixels (e.g., phase detection pixels) of the device to determine in which direction and how far to move or position a lens to achieve improved focus with respect to the target object.

In phase detection autofocus technology, the phase difference or offset may be proportional to a lens position shift from an improved focused position with respect to the target object. Some devices incorporating phase detection autofocus may adjust the lens position until a cross correlation result (e.g., phase difference between a left phase detection pixel and a right phase detection pixel) approaches zero for capturing of an image. For example, some devices may achieve phase detection by dividing incoming light into pairs of images and comparing the images (e.g., determining an offset between the images). In low lighting conditions (e.g., under 5 lux), however, the number of photons received by a pixel may be relatively small. Accordingly, phase detection autofocus technology may suffer from errors in sub-pixel phase difference estimations due to higher amounts of noise (e.g., significantly decreased signal-to-noise ratio (SNR)), resulting in reduced image quality of captured images or video.

In some cases, devices may employ an active light source emitting invisible light (e.g., infrared (IR) light) to illuminate a scene (e.g., a target object or target area). For example, some devices may incorporate an active IR light source and a corresponding IR cutoff filter to prevent reflected IR light from reaching photo-sensitive areas in the devices. However, in such implementations, the IR cutoff filter completely covers the photo-sensitive areas (e.g., the IR cutoff filter is disposed in front of the entirety of an image sensor). For example, in some devices, both non-phase detection pixels (e.g., color pixels, monochrome pixels, etc.) and phase detection pixels are covered by the IR cutoff filter, thereby preventing phase detection pixels from receiving IR photons (e.g., and from performing operations related to autofocus based on the IR light). Further, some devices may include additional sensors (e.g., time-of-flight sensors for measuring object distance) to boost autofocus performance. However, such additional sensors/components may result in significant increases in manufacturing costs and computation effort, which may hinder user convenience and device performance.

The described techniques relate to improved methods, systems, devices, and apparatuses for improving autofocus performance related to image capture. According to aspects described herein, a device may include an image sensor and a filter layer (e.g., a pixelated IR cutoff filter), where the filter layer is directly deposited over non-phase detection pixels (e.g., color pixels, monochrome pixels, or both) of the image sensor but not over phase detection pixels. In some examples, the device may further include a light source (e.g., an active IR light source). Using the improved image sensor together with the light source, the device may provide the phase detection pixels in the image sensor with sufficient amounts of light (e.g., IR light) for improved autofocus and image quality under low lighting conditions (e.g., without adversely affecting captured image quality). For example, a device may perform phase detection autofocus operations using light, including reflected IR light resulting from IR light emitted by the light source, captured by the phase detection pixels. The pixelated filter layer deposited over non-phase detection pixels may prevent the reflected IR light from distorting information captured by the non-phase detection pixels (e.g., which may prevent distortion of an image generated by the device). As the improved methods and devices may be implemented without requiring a time-of-flight sensor or other sensor, manufacturing costs and computation requirements may be reduced.

Particular aspects of the subject matter described herein may be implemented to realize one or more advantages. The described methods, systems, devices, and apparatuses provide techniques which may support active IR light illumination and a pixelated IR cutoff filter for improved phase detection autofocus, among other advantages. As such, supported techniques may include features for phase detection autofocus based on active IR light illumination, which may achieve improvements in autofocus performance (e.g., accuracy, speed) under low light conditions. Additionally, the pixelated IR cutoff filter may prevent active IR light illumination from affecting operation of pixels (e.g., non-phase detection pixels) different from those pixels utilized for phase detection autofocus. The improved techniques may include features for integrating the pixelated IR cutoff filter within an image sensor, which may reduce overall device size, image processing complexity, and device manufacturing costs. Further, the described techniques may be implemented without a time-of-flight sensor or other additional sensor, thereby reducing or minimizing production cost and computation effort associated with image capture and image processing.

Aspects of the disclosure are initially described in the context of an image capture system. Aspects of the disclosure are described with reference to a diagram illustrating an example image sensor. Aspects of the disclosure are further illustrated by and described with reference to apparatus diagrams, system diagrams, and flowcharts that relate to image capture (e.g., lighting, light filtering, etc.).

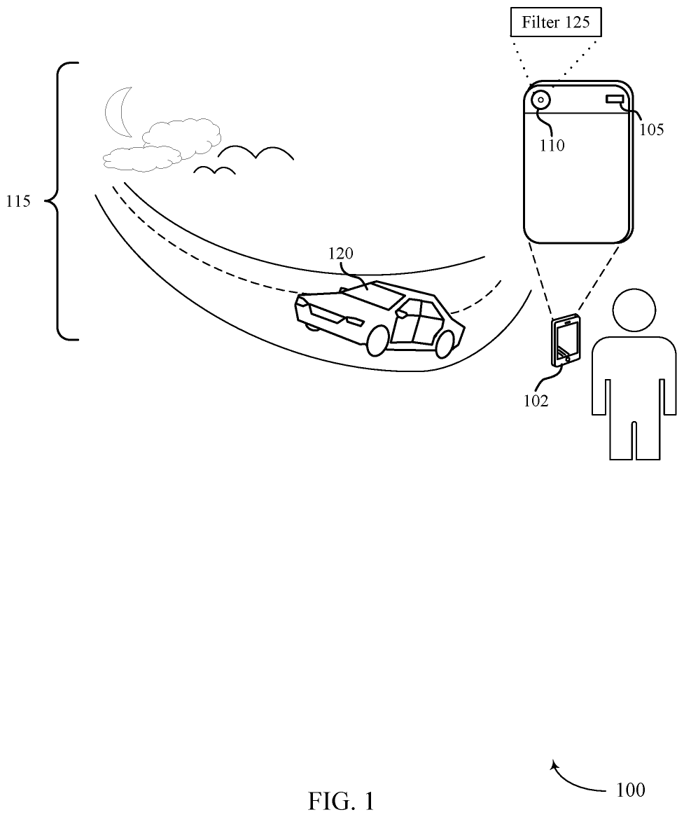

FIG. 1 illustrates an example of a system 100 (e.g., an image capture system, a camera imaging system, etc.) that supports image capture techniques (e.g., lighting and light filtering techniques, autofocus techniques) and image processing in accordance with aspects of the present disclosure. System 100 may include a device 102 that includes light source 105, sensor 110, and filter 125. System 100 may illustrate a user of the device 102 capturing an image of a scene 115 (e.g., including a target object 120) using light source 105, sensor 110, and filter 125 of the device 102. Device 102 may utilize light source 105, sensor 110, and filter 125, according to techniques described herein, to capture an image, a sequence of images, a video stream, etc. of object 120 and/or scene 115. As an example, device 102 may utilize light source 105, sensor 110, and filter 125 to illuminate object 120 and/or scene 115, adjust one or more settings (e.g., autofocus, exposure, white balance) associated with capturing an image of object 120 and/or scene 115 according to lighting conditions (e.g., daytime, nighttime, cloudy, low light), and capture an image of the object 120 and/or scene 115.

Techniques for image capturing (e.g., lighting techniques, light filtering techniques, autofocus techniques) and image processing (e.g., generating an image) under low lighting conditions are described herein. For example, device 102 may employ a light source 105 and a sensor 110 to capture and generate one or more images of object 120 and/or scene 115. The light source 105 may include light sources capable of emitting visible light and/or invisible light. In an example, the light source 105 may include a visible light source and an active invisible light source (e.g., IR light source, near-IR light source, ultraviolet (UV) light source). Sensor 110 may be a camera including phase detection pixels, non-phase detection pixels, and a filter 125. According to examples of aspects described herein, filter 125 may include a filter layer deposited over the set of non-phase detection pixels. In an example, the filter layer may be a pixelated filter layer.

According to aspects described herein, device 102 may emit light from light source 105 and capture an image using sensor 110 (e.g., an image sensor, a camera) based on the emitted light, where the sensor 110 includes a set of non-phase detection pixels, a set of phase detection pixels, and filter 125. Device 102 may perform an autofocus operation based on an image offset associated with at least two of the phase detection pixels and the image. Based on the autofocus operation, device 102 may generate the image. For example, a device 102 may perform phase detection autofocus operations using light, including reflected invisible light resulting from invisible light emitted by the light source 105, captured by the phase detection pixels of the sensor 110. The pixelated filter 125 deposited over non-phase detection pixels of the sensor 110 may prevent the reflected invisible light from distorting information captured by the non-phase detection pixels (e.g., which may prevent distortion of an image generated by the device 102). Generally, a device 102 may employ aspects of the described techniques using any spectrum of light. That is, a device 102 may generally employ aspects of the described techniques using a light source 105 emitting light (e.g., IR light, near-IR light, UV light) and a pixelated filter 125 (e.g., a pixelated IR filter, a pixelated near-IR filter, a pixelated UV filter) for filtering of the light over non-phase detection pixels.

Techniques described with reference to aspects of system 100 are done so for exemplary purposes only, and are not intended to be limiting in terms of the applicability of the described techniques. That is, the techniques described may be implemented in, or applicable to, other imaging examples (e.g., other examples of image sensor or camera based applications, such as security systems, drone imaging, etc.), without departing from the scope of the present disclosure. For example, the techniques described may generally provide for efficient techniques for image capturing (e.g., lighting and light filtering, autofocus techniques) and image processing (e.g., generating an image) under low lighting conditions.

As used herein, a device 102 may refer to any device with a camera, image sensor, light sensor, etc. In some cases, device 102 may refer to a camera, a mobile device, a wireless device, a remote device, a handheld device, a subscriber device, a personal electronic device such as a cellular phone, a personal digital assistant (PDA), a tablet computer, a laptop computer, a personal computer, or some other suitable terminology. Further examples of devices 102 that may implement one or more aspects of image processing techniques may include camcorders, webcams, computer monitors, cockpit controls and/or displays, camera view displays (such as the display of a rear-view camera in a vehicle), etc. The term “device” is not limited to one or a specific number of physical objects (such as one smartphone). As used herein, a device 102 may be any electronic device with multiple parts that may implement at least some portions of this disclosure. For one example, a device 102 may be a video security system including one or more hubs and two or more separate cameras. As another example, a device 102 may be a smartphone including a light source such as light source 105 and a camera such as sensor 110 (inclusive of components such as non-phase detection pixels, phase detection pixels, and filter 125). While the described techniques and examples use the term “device” to describe various aspects of this disclosure, the term “device” is not limited to a specific sensor or hardware configuration, type, or number of objects.

Any of such devices may include at least one light sensor (e.g., sensor 110) that outputs a signal, or information bits, indicative of light (e.g., reflective light characteristics of scene 115 (e.g., which may include a target object 120), light emitted from scene 115, an amount or intensity of light associated with scene 115, red green blue (RGB) values associated with scene 115, IR light values associated with a scene 115, near-IR light values associated with a scene, UV light values associated with a scene, etc.). For example, a sensor 110 may include a lens (e.g., to capture or focus incoming light), a color filter array (CFA) (e.g., to filter the incoming light according to different individual filter elements of the CFA), a pixel sensor array (e.g., to detect or measure the filtered light), and/or other hardware or components for capturing such light or image information. The sensor 110 may then signal or pass information collected to other components of the device 102 (e.g., a camera controller, a processor, etc.). In some aspects, sensor 110 may be a primary camera or an auxiliary camera. Additionally or alternatively, sensor 110 may have a different focal length, capture rate, resolution, color palette (such as color versus black and white), and/or field of view or capture than one or more additional sensors included in the device 102. While described herein with respect to a device including a camera and a light source, aspects of the present disclosure are applicable to any number of cameras, light sources, and camera configurations, and are therefore not limited a single camera, a single light source, or a single camera configuration.

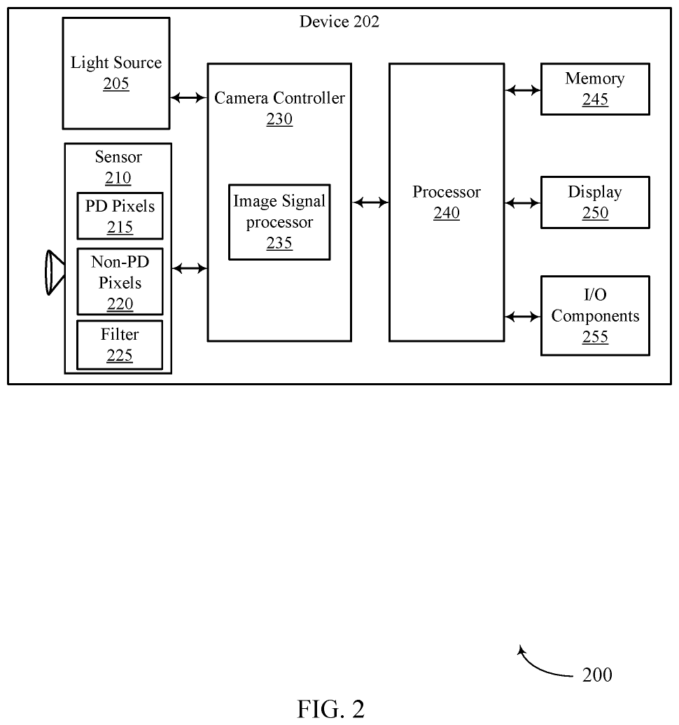

FIG. 2 illustrates an example of a device architecture 200 that supports image capture (e.g., lighting and light filtering techniques, autofocus techniques) and image processing (e.g., image generation techniques) in accordance with aspects of the present disclosure. For example, device architecture 200 may implement aspects of device 102. In an example, device 202 may be an example of aspects of device 102.

Device 202 may be any suitable device capable of capturing images or video including, for example, wired and wireless communication devices (such as camera phones, smartphones, tablets, security systems, dash cameras, laptop computers, desktop computers, automobiles, drones, aircraft, and so on), digital cameras (including still cameras, video cameras, and so on), or any other suitable device. Device 202 may include a light source 205, a sensor 210, a camera controller 230, a processor 240, a memory 245, a display 250, and a number of input/output (I/O) components 255.

Sensor 210 may include phase detection (PD) pixels 215 (e.g., phase detection autofocus pixels), non-phase detection (non-PD) pixels 220 (e.g., color pixels, monochrome pixels), and a filter 225. Sensor 210 may detect an amount or intensity of light associated with scene 115 (e.g., light emitted by or reflected from scene 115). According to example aspects described herein, sensor 210 may detect RGB, monochrome, IR, and/or UV light values associated with scene 115 using a combination of phase detection pixels 215 and non-phase detection pixels 220. In an example, sensor 210 may detect IR and/or UV light values associated with scene 115 using phase detection pixels 215. For example, sensor 210 may capture one or more images (e.g., IR images) associated with scene 115 using phase detection pixels 215. Sensor 210 may detect RGB and/or monochrome values associated with scene 115 using non-phase detection pixels 220. For example, sensor 210 may capture one or more images (e.g., color or monochrome images) associated with scene 115 using non-phase detection pixels 220.

Filter 225 may include one or more filter layers. In an example, filter 225 may include a pixelated filter layer (e.g., a pixelated IR filter layer, a pixelated near-IR filter layer, and a pixelated UV filter layer). According to example aspects described herein, the pixelated filter layer may include a thin-film-based optical filter layer (e.g., physical vapor deposition (PVD) may be used to deposit thin-film-based inference short-pass optical filters on non-phase detection pixels 220). In some examples, the pixelated filter layer may include a mesh structure formed of two or more materials differing based on refractive index and/or thickness. According to aspects described herein, filter 225 may include a pixelated filter layer deposited directly over the set of non-phase detection pixels 220. For example, filter 225 may include a pixelated IR filter layer deposited over non-phase detection pixels 220 which may prevent or reduce (e.g., filter or block) an amount of IR light from reaching non-phase detection pixels 220.

Camera controller 230 may include an image signal processor 235. In some cases, image signal processor 235 may perform image signal processing operations. For example, image signal processor 235 may perform image signal processing operations based on RGB, monochrome, IR, and/or UV light values detected by phase detection pixels 215 and non-phase detection pixels 220. Alternatively or additionally, processor 240 and/or camera controller 230 may perform image signal processing operations. Further, processor 240 and/or camera controller 230 may perform aspects of phase detection auto focus operations described herein (e.g., via processing of information captured by phase detection pixels 215).

Sensor 210 may be in electronic communication with a camera controller 230 and processor 240 (e.g., some image signal processor and/or image signal processing software). In some cases, sensor 210 may be in electronic communication with camera controller 230, and camera controller 230 may be in electronic communication with processor 240. In some examples, camera controller 230 and processor 240 may be implemented on a single substrate or system on chip (SoC), or may be separately located.

Device 202 may be an example of aspects of device 102. For example, light source 205, sensor 210, and filter 225 may be examples of aspects of light source 105, sensor 110, and filter 125. Device 202 may include additional features or components not shown. For example, a wireless interface, which may include a number of transceivers and a baseband processor, may be included for a wireless communication device. In some cases, device 202 may include additional sensors or cameras other than sensor 210. The disclosure should not be limited to any specific examples or illustrations, including example device 202.

As discussed herein, sensor 210 may generally refer to a camera, an image sensor, a light sensor, other sensors, or the like. For example, sensor 210 may include a lens, a color filter array, a pixel sensor array, and/or other hardware which may collect (e.g., focus), filter, and detect lighting information. Device 202 may pass the lighting information to camera controller 230 (e.g., for processing and reconstruction of the raw image data by image signal processor 235). Image signal processor 235 (e.g., one or more driver circuits for performing image processing operations) may then process the information collected by the sensor 210 (e.g., to reconstruct or restore the captured image of scene 115 and/or object 120). In some examples, the processed image information (e.g., determined or output from the camera controller 230, image signal processor 235, and/or processor 240) may then be passed to a display 250 of the device 202. In other examples, the processed image information may be stored by device 202, passed to another device, etc. Camera controller 230 may include one or more driver circuits for controlling sensor 210.

The sensor 210 may be capable of capturing individual image frames (such as still images) and/or capturing video (such as a succession of captured image frames). In some cases, sensor 210 may include one or more image sensors (not shown for simplicity) or pixel arrays (e.g., phase detection pixels 215 and non-phase detection pixels 220) and shutters for capturing an image frame and providing the captured image frame to the camera controller 230. Memory 245 may be a non-transient or non-transitory computer readable medium storing computer executable instructions to perform all or a portion of one or more operations described in this disclosure. In some cases, device 202 may also include a power supply, which may be coupled to or integrated into device 202.

In some cases, sensor 210 may refer to a complementary metal oxide semiconductor (CMOS) image sensor, a charge-coupled device (CCD), etc. used in digital imaging applications to capture images (e.g., scenes 115, target objects 120 within some scene 115, etc.). In some examples, sensor 210 may include an array of sensors (e.g., a pixel sensor array including phase detection pixels 215 and non-phase detection pixels 220). Each sensor in the pixel sensor array may include at least one photosensitive element for outputting a signal having a magnitude proportional to the intensity of incident light or radiation contacting the photosensitive element. When exposed to incident light (e.g., visible light, invisible light) reflected by or emitted from a scene 115 (e.g., or target object 120 within some scene 115), each sensor or pixel in the pixel sensor array may output a signal having a magnitude corresponding to an intensity of light at one point in the scene 115 (e.g., at an image capture time). The signals output from each photosensitive element may be processed (e.g., by the camera controller 230, image signal processor 235, and/or processor 240) to form an image representing the captured scene or object.

In general, a pixel brightness measurement or a pixel value from sensor 210 (e.g., from pixel sensor array) may correspond to a pixel intensity value, RGB values of a pixel, infrared values of a pixel, or any other parameter associated with light (e.g., or the image being captured, the picture being taken, etc.). As an example, a pixel sensor array may include one or more photosensitive elements for measuring such information. In some examples, the photosensitive elements may have a sensitivity to a spectrum of electromagnetic radiation (e.g., including the visible spectrum of electromagnetic radiation, infrared spectrum of electromagnetic radiation, etc.). For example, the at least one photosensitive element may be tuned for sensitivity to a visible spectrum of electromagnetic radiation (e.g., by way of depth of a photodiode depletion region associated with the photosensitive element).

Processor 240 may be one or more suitable processors capable of executing scripts or instructions of one or more software programs (such as instructions) stored within memory 245. In some aspects, processor 240 may be one or more general purpose processors that execute instructions to cause the device 202 to perform any number of functions or operations. In additional or alternative aspects, processor 240 may include integrated circuits or other hardware to perform functions or operations without the use of software. While shown to be coupled to each other via processor 240 in the example of FIG. 2, processor 240, memory 245, camera controller 230, the display 250, and I/O components 255 may be coupled to one another in various arrangements. For example, processor 240, memory 245, camera controller 230, display 250, and/or I/O components 255 may be coupled to each other via one or more local buses (not shown for simplicity).

Display 250 may be any suitable display or screen allowing for user interaction and/or to present items (such as captured images and video) for viewing by a user. In some aspects, display 250 may be a touch-sensitive display. I/O components 255 may be or may include any suitable mechanism, interface, or device to receive input (such as commands) from the user and to provide output to the user. For example, I/O components 255 may include (but are not limited to) a graphical user interface, keyboard, mouse, microphone and speakers, and so on.

Camera controller 230 may include an image signal processor 235, which may be one or more image signal processors to process captured image frames or video provided by the sensor 210. In some example implementations, camera controller 230 (such as image signal processor 235) may control operation of sensor 210. In some aspects, image signal processor 235 may execute instructions from a memory (such as instructions from memory 245 or instructions stored in a separate memory coupled to the image signal processor 235) to control operation of sensor 210. In other aspects, camera controller 230 may include specific hardware to control operation of sensor 210. The camera controller 230 and/or image signal processor 235 may additionally or alternatively include a combination of specific hardware and the ability to execute software instructions.

According to aspects described herein, device 202 may determine lighting conditions associated with capturing an image of scene 115 and/or target object 120. In an example, device 202 may identify a low lighting condition (e.g., 5 lux or less) and emit light (e.g., invisible light, for example, IR light) from light source 205. According to example aspects described herein, device 202 may capture an image using sensor 210 based on the emitted light. In an example, device 202 may capture an image based on incident light (e.g., visible light and invisible light, for example, IR light) reflected or emitted from scene 115 or target object 120.

According to example aspects described herein, sensor 210 may capture IR light associated with scene 115 or target object 120. In an example, sensor 210 may capture one or more images (e.g., IR images) associated with scene 115 based on IR light (e.g., IR light values) detected by phase detection pixels 215. In an example, each of the phase detection pixels 215 may output a signal having a magnitude corresponding to an intensity of light (e.g., IR light values) at a point in the scene 115. According to example aspects described herein, device 202 may determine an image offset (e.g., a phase offset) associated with the signals from phase detection pixels 215. For example, device 202 may determine an image offset associated with (e.g., based on a comparison of) at least two IR images captured using phase detection pixels 215 (e.g., using opposing phase detection pixels 215). In an example, device 202 may perform an autofocus operation (e.g., using phase detection autofocus) for eliminating or reducing the image offset. For example, device 202 may confirm, set, and/or modify one or more focus (e.g., lens focus) settings based on the image offset.

According to aspects described herein, sensor 210 may capture one or more color or monochrome images associated with scene 115 based on visible light detected by non-phase detection pixels 220 (e.g., color pixels, monochrome pixels) and IR light (e.g., detected IR, and/or UV light values) detected by phase detection pixels 215. For example, device 202 may capture one or more color or monochrome images associated with scene 115 based on the autofocus operation (e.g., using phase detection autofocus, phase detection pixels 215, and IR light) described herein.

Additionally or alternatively, in an example where the non-phase detection pixels 220 include color pixels (or monochrome pixels), the autofocus operation may include a contrast autofocus operation performed based on a contrast level associated with at least two color pixels included in the non-phase detection pixels 220 and the one or more color (or monochrome) images associated with scene 115. Accordingly, device 202 may capture one or more color or monochrome images associated with scene 115 based on the autofocus operation (e.g., using contrast autofocus, non-phase detection pixels 220, and visible light).

According to example aspects described herein, device 202 may generate one or more color or monochrome images based on the autofocus operation (e.g., the autofocus operation using phase detection autofocus, phase detection pixels 215, and IR light and/or the autofocus operation using contrast autofocus, non-phase detection pixels 220, and visible light). For example, device 202 (e.g., camera controller 230, image signal processor 235, and/or processor 240) may process information (e.g., visible light) collected by non-phase detection pixels 220 of the sensor 210 and generate one or more corresponding images (e.g., one or more color or monochrome images associated with scene 115) based on the autofocus operation described herein. As described herein, in some examples, device 202 may pass the processed image information to display 250 of device 202.

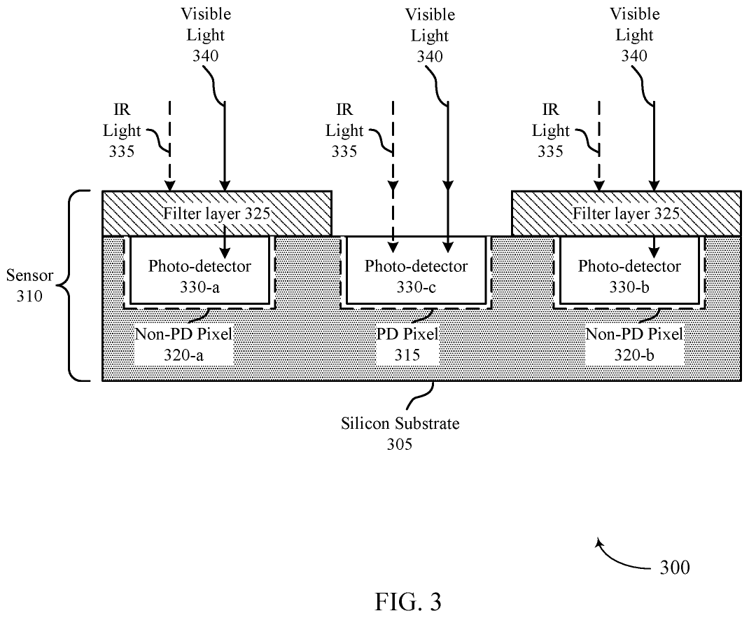

FIG. 3 illustrates an example image capture diagram 300 that supports aspects of an image sensor with a pixelated cutoff filter for phase detection autofocus in accordance with examples of aspects described herein. In some examples, image sensor 310 may implement aspects of device 102. Image sensor 310 may be an example of aspects of image sensor 110 and image sensor 210.

In example image capture diagram 300, sensor 310 may include a silicon substrate 305, phase detection pixels 315, non-phase detection pixels 320, and filter layer 325. In an example, each of phase detection pixels 315 and non-phase detection pixels 320 may include a photodetector 330. For example, as illustrated in FIG. 3, non-phase detection pixel 320-a may include photodetector 330-a, non-phase detection pixel 320-b may include photodetector 330-b, and phase detection pixel 315 may include photodetector 330-c. In an example, phase detection pixels 315, non-phase detection pixels 320, and filter layer 325 may be formed via a mask process, for example, via a photolithography (e.g., optical lithography or UV lithography) process.

According to example aspects described herein, filter layer 325 may include a pixelated filter layer. According to example aspects described herein, filter layer 325 may be formed via PVD. In an example, filter layer 325 may be formed of a material opaque or partially opaque in with respect to the visible light spectrum (e.g., a material which prevents transmission of 100 percent or nearly 100 percent of light in the visible light spectrum). For example, filter layer 325 may be formed of Calcium Fluoride (CaF2), Fused Silica (FS), Germanium (Ge), Magnesium Fluoride (MgF2), N-BK7, Potassium Bromide (KBr), Sapphire, Silicon (Si), Sodium Chloride (NaCl), Zinc Selenide (ZnSe), Zinc Sulfide (ZnS), or any combination thereof. In an example, filter layer 325 may be a pixelated filter layer including a mesh structure formed of two or more materials which are opaque or partially opaque in with respect to the visible light spectrum as described herein. According to example aspects described herein, the two or more materials may differ based on a refractive index (n_{d}), a thickness, or both. For example, the refractive indexes of the materials may range from 1.38-4. According to example aspects described herein, the two or more materials may be partially or fully interlaced within the mesh structure.

In the example of FIG. 3, filter layer 325 may be deposited over non-phase detection pixels included in the sensor 310 (e.g., over non-phase detection pixel 320-a and non-phase detection pixel 320-b). In an example, filter layer 325 may be directly deposited over non-phase detection pixels (e.g., over non-phase detection pixel 320-a and non-phase detection pixel 320-b, such that there is no gap between filter layer 325 and non-phase detection pixels 320-a and 320-b, such that filter layer 325 and non-phase detection pixel 320-a are manufactured as a single component, etc.). In an example, filter layer 325 may be deposited only over non-phase detection pixels included in the sensor 310, and not over phase detection pixels (e.g., phase detection pixel 315), such that the phase detection pixels (e.g., phase detection pixel 315) are clear.

Filter layer 325, as described herein, may provide advantages compared to filter layers implemented in other devices. For example, instead of disposing a filter layer (e.g., an IR cutoff filter) in front of the entirety of an image sensor (e.g., or as a separate component in front of the image sensor), examples of aspects described herein may utilize elements of nano-fabrication technology to deposit an IR cutoff filter (e.g., filter layer 325) only over regular pixels (e.g., non-phase detection pixels 320, for example, color pixels and/or monochrome pixels), and not over phase detection pixels (e.g., phase detection pixel 315). According to examples of aspects described herein, IR cutoff filter (e.g., filter layer 325) may be directly deposited over the regular pixels (e.g., non-phase detection pixels 320, for example, color pixels and/or monochrome pixels). Accordingly, light which is incident on sensor 310 may reach only a portion of pixels included sensor 310. For example, as illustrated in FIG. 3, visible light 340 reaches both phase detection pixel 315 (e.g., photodetector 330-c) and non-phase detection pixels 320-a and 320-b (e.g., photodetectors 330-a and 330-b), whereas IR light 335 only reaches phase detection pixel 315 (e.g., photodetector 330-c). For example, filter layer 325 may prevent or reduce an amount of IR light 335 from reaching non-phase detection pixels 320-a and 320-b (e.g., photodetectors 330-a and 330-b).

Particular aspects of the subject matter described herein may be implemented to realize one or more advantages. The described methods, systems, devices, and apparatuses provide techniques which may support active IR light illumination and a pixelated IR cutoff filter (e.g., filter layer 325) for phase detection autofocus, among other advantages. As such, using image sensor 310 described herein together with active IR light illumination, phase detection pixels (e.g., phase detection pixel 315) included in image sensor 310 may receive sufficient amounts of light under low light conditions. Accordingly, the described methods, systems, devices, and apparatuses provide techniques which may achieve improvements in autofocus performance (e.g., accuracy, speed).

Additionally, the pixelated IR cutoff filter (e.g., filter layer 325) may prevent active IR light illumination from affecting operation of regular pixels (e.g., non-phase detection pixels 320-a and 320-b). Other devices, which differ from example aspects as described herein, may disadvantageously implement an IR cutoff filter (e.g., IR filter layer) as a component separate from an image sensor (e.g., separate from sensor 310), as opposed to being integrated with the image sensor. For example, other devices have implemented an IR cutoff filter as a single pane/piece of glass deposited over the entirety of an image sensor (e.g., over both phase detection pixels and non-phase detection pixels) such that a gap (e.g., a 4 mm gap) exists between pixels in the sensor and the IR cutoff filter. Further, devices for capturing and processing images as described herein may be implemented without a time-of-flight sensor or other additional sensor, thereby reducing or minimizing associated production cost and computation effort.

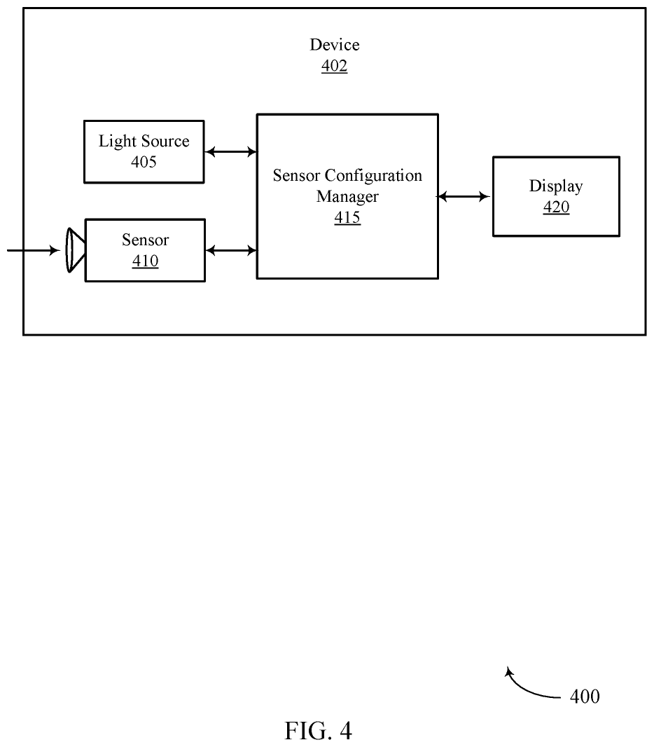

FIG. 4 shows a block diagram 400 of a device 402 that supports an image sensor with a pixelated cutoff filter for phase detection autofocus in accordance with aspects of the present disclosure. The device 402 may be an example of aspects of a device as described herein. The device 402 may include one or more light sources 405, one or more sensors 410, a sensor configuration manager 415, and a display 420. The device 402 may also include a processor. Each of these components may be in communication with one another (e.g., via one or more buses).

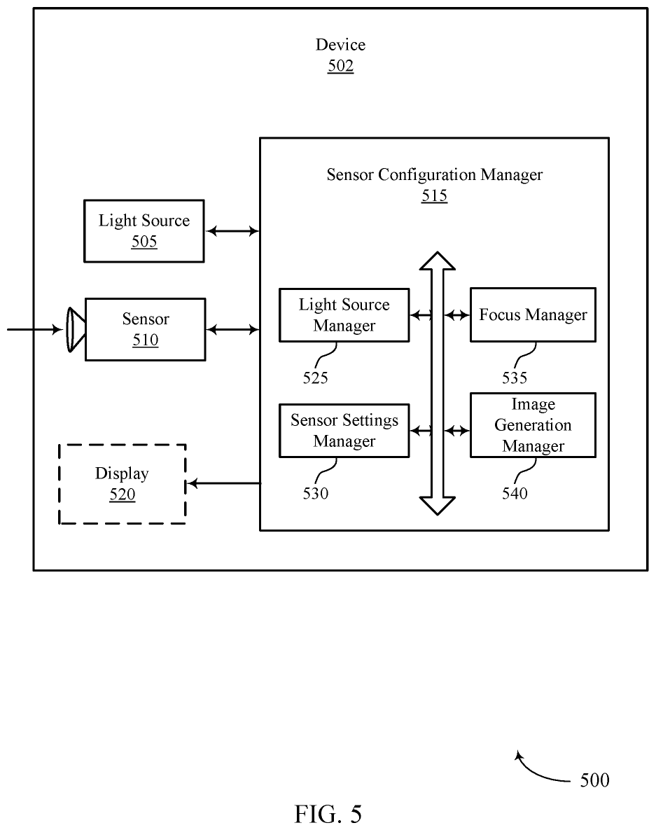

The one or more light sources 405 may include light sources capable of emitting visible light and/or invisible light. In an example, the light sources 405 may include a visible light source and an active invisible light source (e.g., IR light source, near-IR light source, UV light source). In some cases, the light sources 405 may be an example of aspects of the light source 505 described with reference to FIG. 5.

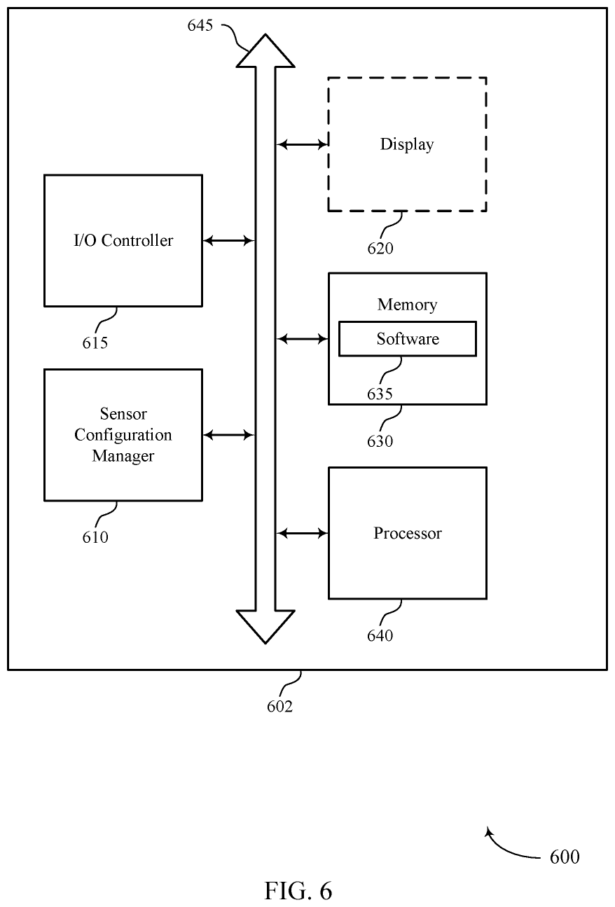

The one or more sensors 410 (e.g., image sensors, cameras, etc.) may receive information (e.g., light, for example, visible light and/or invisible light), which may be passed on to other components of the device 402. In some cases, the sensors 410 may be an example of aspects of the I/O controller 615 described with reference to FIG. 6. A sensor 410 may utilize one or more photosensitive elements that have a sensitivity to a spectrum of electromagnetic radiation to receive information (e.g., to receive a pixel intensity value, RGB values, IR light values, near-IR light values, UV light values of a pixel, etc.). The information may then be passed on to other components of the device 402.

The sensor configuration manager 415 may emit light from a light source 405, capture one or more images using an image sensor 410 based on the emitted light, where the image sensor includes a set of non-phase detection pixels, a set of phase detection pixels, and a pixelated filter layer deposited over the set of non-phase detection pixels, perform an autofocus operation based on an image offset associated with at least two phase detection pixels in the set of phase detection pixels and the one or more images, and generate the one or more images based on the autofocus operation.

The sensor configuration manager 415 as described herein may be implemented to realize one or more potential advantages. One implementation may allow the device 402 to provide techniques which may support active IR light illumination and a pixelated IR cutoff filter for phase detection autofocus, among other advantages, among other advantages. For example, the device 402 may include features for improvements in autofocus performance (e.g., accuracy, speed) under low light conditions, as the device 402 includes features for phase detection autofocus based on active IR light illumination. Additionally or alternatively, the device 402 may include features for preventing active IR light illumination from affecting operation of pixels (e.g., non-phase detection pixels) different from pixels utilized for phase detection autofocus, as the sensor 410 included in device 402 may include a pixelated IR cutoff filter deposited over non-phase detection pixels. Additionally or alternatively, the device 402 may include features for reducing overall device size, complexity, and associated manufacturing costs, as the device 402 may integrate the pixelated IR cutoff filter within an image sensor (e.g., sensor 410). Additionally or alternatively, the device 402 may include features for reducing or minimizing production cost and computation effort associated with image capture and image processing, as the device 402 may implement the capturing and processing of images without a time-of-flight sensor or other additional sensor. The sensor configuration manager 415 may be an example of aspects of the sensor configuration manager 610 described herein.

The sensor configuration manager 415, or its sub-components, may be implemented in hardware, code (e.g., software or firmware) executed by a processor, or any combination thereof. If implemented in code executed by a processor, the functions of the sensor configuration manager 415, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The sensor configuration manager 415, or its sub-components, may be physically located at various positions, including being distributed such that portions of functions are implemented at different physical locations by one or more physical components. In some examples, the sensor configuration manager 415, or its sub-components, may be a separate and distinct component in accordance with various aspects of the present disclosure. In some examples, the sensor configuration manager 415, or its sub-components, may be combined with one or more other hardware components, including but not limited to an input/output (I/O) component, a camera controller, another computing device, one or more other components described in the present disclosure, or a combination thereof in accordance with various aspects of the present disclosure.

The display 420 may be any suitable display or screen allowing for user interaction and/or allowing for presentation of information (such as captured images and video) for viewing by a user. In some aspects, the display 420 may be a touch-sensitive display. In some cases, the display 420 may display images captured by sensor 410, where the displayed images that are captured by sensor 410 may depend on the configuration of light source 405 and sensor 410 by the sensor configuration manager 415.

FIG. 5 shows a block diagram 500 of a device 502 that supports an image sensor with a pixelated cutoff filter for phase detection autofocus in accordance with aspects of the present disclosure. The device 502 may be an example of aspects of a device 102, a device 202, a device 402 or a device as described herein. The device 502 may include one or more light sources 505, one or more sensors 510, a sensor configuration manager 515, and a display 520. The sensor configuration manager 515 may be an example of aspects of a sensor configuration manager 415, or a sensor configuration manager 610 described herein. The sensor configuration manager 515 may include light source manager 525, sensor settings manager 530, focus manager 535, and image generation manager 540. The device 502 may also include a processor. Each of these modules may communicate, directly or indirectly, with one another (e.g., via one or more buses).

The one or more light sources 505 may include light sources capable of emitting visible light and/or invisible light. In an example, the light sources 505 may include a visible light source and an active invisible light source (e.g., IR light source, near-IR light source, UV light source). In some cases, the light sources 505 may be an example of aspects of the light source 405 described with reference to FIG. 4 and light source 505 described with reference to FIG. 5.

The one or more sensors 510 (e.g., image sensors, cameras, etc.) may receive information (e.g., light), which may be passed on to other components of the device 502. In some cases, the sensors 510 may be an example of aspects of the I/O controller 615 described with reference to FIG. 6. As discussed above, the sensors 510 may utilize one or more photosensitive elements that have a sensitivity to a spectrum of electromagnetic radiation to receive information (e.g., to receive a pixel intensity value, RGB values of a pixel, etc.). The information may then be passed on to other components of the device 502.

The light source manager 525 may control the amount or type of light emitted from light source 505. The sensor settings manager 530 may capture one or more images using an image sensor 510 based on the emitted light, where the image sensor 510 includes a set of non-phase detection pixels, a set of phase detection pixels, and a pixelated filter layer deposited over the set of non-phase detection pixels. The focus manager 535 may perform an autofocus operation based on an image offset associated with at least two phase detection pixels in the set of phase detection pixels and the one or more images.

The image generation manager 540 may generate the one or more images based on the autofocus operation. The display 520 may be any suitable display or screen allowing for user interaction and/or allowing for presentation of information (such as captured images and video) for viewing by a user. In some aspects, the display 520 may be a touch-sensitive display. In some cases, the display 520 may display images captured by sensor 510, where the displayed images that are captured by sensor 510 may depend on the configuration of light source 505 and sensor 510 by the sensor configuration manager 515.

FIG. 6 shows a diagram of a system 600 including a device 602 that supports an image sensor with a pixelated cutoff filter for phase detection autofocus in accordance with aspects of the present disclosure. The device 602 may be an example of or include the components of device 402, device 502, or a device as described herein. The device 602 may include a sensor configuration manager 610, an I/O controller 615, display 620, memory 630, and a processor 640. These components may be in electronic communication via one or more buses (e.g., bus 645).

The sensor configuration manager 610 may emit light from a light source. In some cases, the light source includes one or more of an infrared light source, a near-infrared light source, and an ultraviolet light source.

The sensor configuration manager 610 may capture one or more images using an image sensor based on the emitted light, where the image sensor includes a set of non-phase detection pixels, a set of phase detection pixels, and a pixelated filter layer deposited over the set of non-phase detection pixels. In some examples, the sensor configuration manager 610 may identify a low lighting condition, where the emitted light may be based on the identified low lighting condition. In some cases, the set of non-phase detection pixels includes a set of color pixels. In some cases, the set of non-phase detection pixels includes a set of color pixels, a set of monochrome pixels, or both. In some cases, the set of phase detection pixels includes a set of phase detection autofocus pixels.

The sensor configuration manager 610 may perform an autofocus operation based on an image offset associated with at least two phase detection pixels in the set of phase detection pixels and the one or more images. In some examples, the sensor configuration manager 610 may perform a contrast autofocus operation based on a contrast level associated with at least two color pixels in the set of color pixels and the one or more images.

The sensor configuration manager 610 may generate the one or more images based on the autofocus operation. In some examples, the sensor configuration manager 610 may process the one or more images based on the set of non-phase detection pixels and the autofocus operation, and may generate the one or more images based on the processing. In some examples, the sensor configuration manager 610 may generate the one or more images further based on the contrast autofocus operation. The sensor configuration manager 415 may be an example of aspects of the sensor configuration manager 610 described herein.

The I/O controller 615 may manage input and output signals for the device 602. In some cases, the I/O controller 615 may refer to or control one or more light sources (e.g., such as light sources 405) and/or one or more sensors (e.g., such as sensors 410). The I/O controller 615 may also manage peripherals not integrated into the device 602. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 602 via the I/O controller 615 or via hardware components controlled by the I/O controller 615.

The memory 630 may include RAM and ROM. The memory 630 may store computer-readable, computer-executable code or software 635 including instructions that, when executed, cause the processor to perform various functions described herein. In some cases, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 602 to perform various functions (e.g., functions or tasks supporting phase detection autofocus).

The software 635 may include instructions to implement aspects of the present disclosure, including instructions to support image processing. The software 635 may be stored in a non-transitory computer-readable medium such as system memory or other type of memory. In some cases, the software 635 may not be directly executable by the processor 640 but may cause a computer (e.g., when compiled and executed) to perform functions described herein.

The display 620 may be any suitable display or screen allowing for user interaction and/or allowing for presentation of information (such as captured images and video) for viewing by a user. In some aspects, the display 620 may be a touch-sensitive display. In some cases, the display 620 may display images captured by sensors, where the displayed images that are captured by sensors may depend on the configuration of light sources and active sensors by the sensor configuration manager 610.

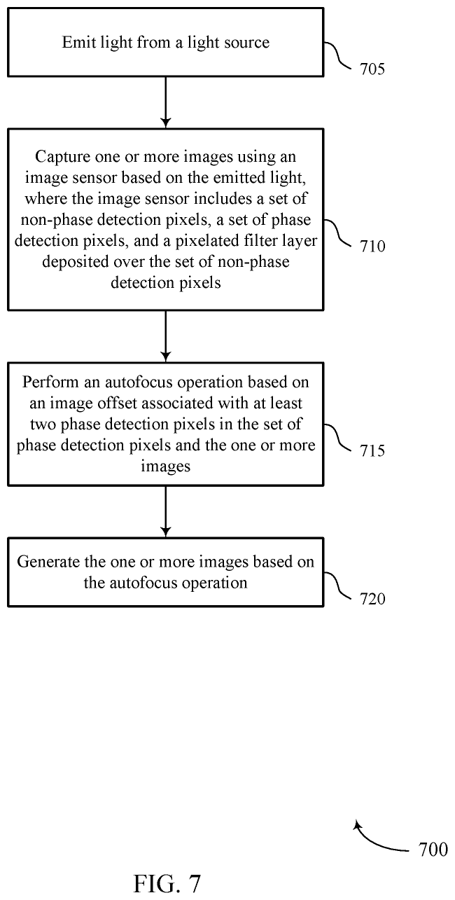

FIG. 7 shows a flowchart illustrating a method 700 that supports image sensor with pixelated cutoff filter for phase detection auto focus in accordance with aspects of the present disclosure. The operations of method 700 may be implemented by a device or its components as described herein. For example, the operations of method 700 may be performed by a controller as described with reference to FIGS. 4 through 6. In some examples, a device may execute a set of instructions to control the functional elements of the device to perform the functions described below. Additionally or alternatively, a device may perform aspects of the functions described below using special-purpose hardware.

At 705, the device may emit light from a light source. The operations of 705 may be performed according to the methods described herein. In some examples, aspects of the operations of 705 may be performed by a light emitting component as described with reference to FIGS. 4 through 6.

At 710, the device may capture one or more images using an image sensor based on the emitted light, where the image sensor includes a set of non-phase detection pixels, a set of phase detection pixels, and a pixelated filter layer deposited over the set of non-phase detection pixels. The operations of 710 may be performed according to the methods described herein. In some examples, aspects of the operations of 710 may be performed by a sensor component as described with reference to FIGS. 4 through 6.

At 715, the device may perform an autofocus operation based on an image offset associated with at least two phase detection pixels in the set of phase detection pixels and the one or more images. The operations of 715 may be performed according to the methods described herein. In some examples, aspects of the operations of 715 may be performed by a focus component as described with reference to FIGS. 4 through 6.

At 720, the device may generate the one or more images based on the autofocus operation. The operations of 720 may be performed according to the methods described herein. In some examples, aspects of the operations of 720 may be performed by an image generating component as described with reference to FIGS. 4 through 6.

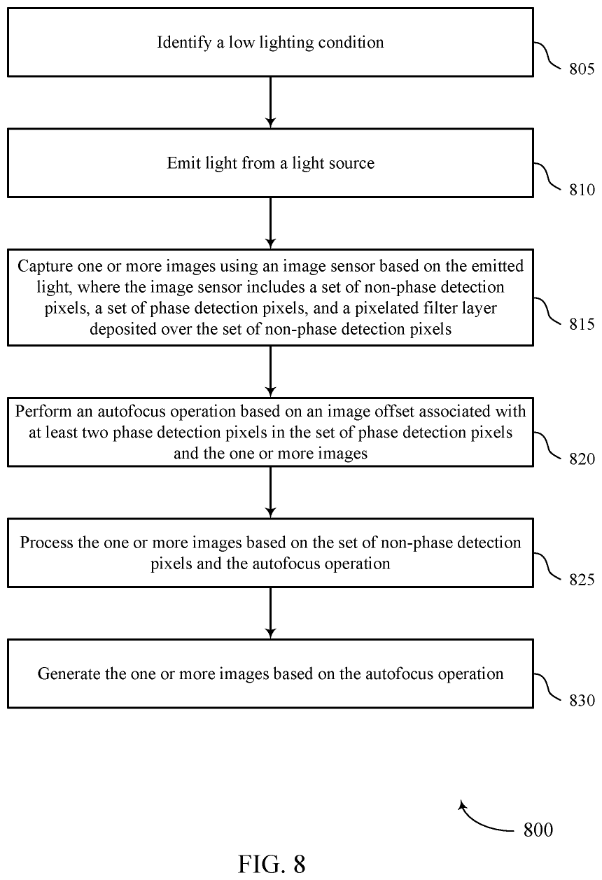

FIG. 8 shows a flowchart illustrating a method 800 that supports an image sensor with a pixelated cutoff filter for phase detection autofocus in accordance with aspects of the present disclosure. The operations of method 800 may be implemented by a device or its components as described herein. For example, the operations of method 800 may be performed by a sensor configuration manager as described with reference to FIGS. 4 through 6. In some examples, a device may execute a set of instructions to control the functional elements of the device to perform the functions described below. Additionally or alternatively, a device may perform aspects of the functions described below using special-purpose hardware.

At 805, the device may identify a low lighting condition. The operations of 805 may be performed according to the methods described herein. In some examples, aspects of the operations of 805 may be performed by a sensor or a sensor configuration manager as described with reference to FIGS. 4 through 6.

At 810, the device may emit light from a light source based on the identifying. The operations of 810 may be performed according to the methods described herein. In some examples, aspects of the operations of 810 may be performed by a light source or a sensor configuration manager as described with reference to FIGS. 4 through 6.

At 815, the device may capture one or more images using an image sensor based on the emitted light, where the image sensor includes a set of non-phase detection pixels, a set of phase detection pixels, and a pixelated filter layer deposited over the set of non-phase detection pixels. The operations of 815 may be performed according to the methods described herein. In some examples, aspects of the operations of 815 may be performed by a sensor or a sensor configuration manager as described with reference to FIGS. 4 through 6.

At 820, the device may perform an autofocus operation based on an image offset associated with at least two phase detection pixels in the set of phase detection pixels and the one or more images. The operations of 820 may be performed according to the methods described herein. In some examples, aspects of the operations of 820 may be performed by a focus manager or a sensor configuration manager as described with reference to FIGS. 4 through 6.

At 825, the device may process the one or more images based on the set of non-phase detection pixels and the autofocus operation. The operations of 825 may be performed according to the methods described herein. In some examples, aspects of the operations of 825 may be performed by an image generation manager or a sensor configuration manager as described with reference to FIGS. 4 through 6.

At 830, the device may generate the one or more images based on the autofocus operation (e.g., based on the processing of the one or more images based on the set of non-phase detection pixels and the autofocus operation). The operations of 830 may be performed according to the methods described herein. In some examples, aspects of the operations of 830 may be performed by an image generation manager or a sensor configuration manager as described with reference to FIGS. 4 through 6.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
emitting light from a light source;
capturing one or more images using an image sensor based at least in part on the emitted light, wherein the image sensor comprises a set of non-phase detection pixels, a set of phase detection pixels, and a pixelated filter layer deposited over the set of non-phase detection pixels;
performing an autofocus operation based at least in part on an image offset associated with at least two phase detection pixels in the set of phase detection pixels and the one or more images; and
generating the one or more images based at least in part on the autofocus operation.

2. The method of claim 1, further comprising:
identifying a low lighting condition, wherein the emitted light is based at least in part on the identified low lighting condition.

3. The method of claim 1, further comprising:
processing the one or more images based at least in part on the set of non-phase detection pixels and the autofocus operation, wherein the one or more images are generated based at least in part on the processing.

4. The method of claim 1, wherein:
the light source comprises one or more of an infrared light source, a near-infrared light source, and an ultraviolet light source; and
the pixelated filter layer comprises one or more of a pixelated infrared filter layer, a pixelated near-infrared filter layer, and a pixelated ultraviolet filter layer.

5. The method of claim 1, wherein the pixelated filter layer is directly deposited over the set of non-phase detection pixels.

6. The method of claim 5, wherein the pixelated filter layer is deposited only over the set of non-phase detection pixels.

7. The method of claim 1, wherein the set of non-phase detection pixels comprises a set of color pixels.

8. The method of claim 7, further comprising:
performing a contrast autofocus operation based at least in part on a contrast level associated with at least two color pixels in the set of color pixels and the one or more images;
wherein generating the one or more images is further based at least in part on the contrast autofocus operation.

9. The method of claim 1, wherein the set of non-phase detection pixels comprises a set of color pixels, a set of monochrome pixels, or both.

10. The method of claim 1, wherein the set of phase detection pixels comprise a set of phase detection autofocus pixels.

11. The method of claim 1, wherein the pixelated filter layer comprises a thin-film-based optical filter layer.

12. The method of claim 1, wherein the pixelated filter layer comprises a mesh structure formed of two or more materials.

13. The method of claim 12, wherein the two or more materials are at least partially interlaced within the mesh structure.

14. The method of claim 12, wherein the two or more materials differ based at least in part on one or more of a refractive index and a thickness of each of the two or more materials.

15. An apparatus for image processing at a device, comprising:
a processor,
memory coupled with the processor; and
instructions stored in the memory and executable by the processor to cause the apparatus to:
emit light from a light source;
capture one or more images using an image sensor based at least in part on the emitted light, wherein the image sensor comprises a set of non-phase detection pixels, a set of phase detection pixels, and a pixelated filter layer deposited over the set of non-phase detection pixels;
perform an autofocus operation based at least in part on an image offset associated with at least two phase detection pixels in the set of phase detection pixels and the one or more images; and
generate the one or more images based at least in part on the autofocus operation.

16. The apparatus of claim 15, wherein the instructions are further executable by the processor to cause the apparatus to:
process the one or more images based at least in part on the set of non-phase detection pixels and the autofocus operation, wherein the one or more images are generated based at least in part on the processing.

17. The apparatus of claim 15, wherein:
the light source comprises one or more of an infrared light source, a near-infrared light source, and an ultraviolet light source; and
the pixelated filter layer comprises one or more of a pixelated infrared filter layer, a pixelated near-infrared filter layer, and a pixelated ultraviolet filter layer.

18. The apparatus of claim 15, wherein the pixelated filter layer is directly deposited over the set of non-phase detection pixels.

19. The apparatus of claim 18, wherein the pixelated filter layer is deposited only over the set of non-phase detection pixels.

20. An apparatus for image processing at a device, comprising:
means for emitting light from a light source;
means for capturing one or more images using an image sensor based at least in part on the emitted light, wherein the image sensor comprises a set of non-phase detection pixels, a set of phase detection pixels, and a pixelated filter layer deposited over the set of non-phase detection pixels;
means for performing an autofocus operation based at least in part on an image offset associated with at least two phase detection pixels in the set of phase detection pixels and the one or more images; and
means for generating the one or more images based at least in part on the autofocus operation.
